(19) United States
(12) Patent Application Publication
(10) Pub. No.: US 2022/0269999 A1
(43) Pub. Date: Aug. 25, 2022

(54) Computer-Implemented System and Method for Renting Excess Storage Space

(71) Applicant: Ramesh Arumugam, Houston, TX (US)

(72) Inventor: Ramesh Arumugam, Houston, TX (US)

(21) Appl. No.: 17/181,023

(22) Filed: Feb. 22, 2021

(51) Int. Cl. G06Q 10/02; G06Q 30/06; G06Q 50/16; G06Q 30/02; G06Q 40/08; G06Q 20/08

(52) U.S. Cl. CPC G06Q 10/02; G06Q 30/0645; G06Q 50/163; G06Q 30/0277; G06Q 40/08; G06Q 20/085; G06Q 30/0206

(57) ABSTRACT

A system and method for renting excess storage space provides an online platform for a storage space owner to rent out extra storage space to a renter. The method is operative to establish interactive communication between the storage space owner and the renter, allowing each party to input parameters so that an algorithm can compute and recommend a storage space that meets the renter's location requirements, required storage space size, budget, and time availability. The storage space renter inputs one or more storage space parameters. Similarly, the renter inputs one or more storage item parameters. An algorithm calculates the parameters from both parties to determine the appropriate location, storage space dimensions, quantity and size of cardboard boxes for storing the items, and final price for the storage space. Based on the calculation, the storage space owner and the renter are matched, and allowed to communicate for transacting the rental agreement.

### FIELD OF THE INVENTION

The present invention relates generally to a computer-implemented system and method for renting excess storage space. More so, the present invention relates to a system that allows a storage space owner to rent out extra storage space to a renter based on inputted parameters from both parties; whereby the storage space renter inputs storage space parameters, including: location of the available storage space, dimensions of the available storage space, and time availability of the storage space; whereby the renter inputs storage item parameters, including: a desired location, a budget limit, a desired length of storage time, approximate quantity and dimensions of items, and dangerous effect of the items, if any; whereby an algorithm calculates the parameters from both parties to determine the appropriate location, storage space dimensions, quantity and size of cardboard boxes for storing the items, and final storage fee, deposits, and hazard fees.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a self-storage facility is a storage space for rent, usually on a month-to-month basis. The self-storage facility includes a number of individual storage spaces or cubicles that may be separated from each other by common walls and have separate entrances. The storage spaces are generally rented to individual customers or business entities for the purpose of storing personal property. For example, a home owner changing homes may wish to temporarily store personal items, such as furniture, electronics, household items, and vehicles in a storage facility before moving into a new home. In this manner, self-storage facilities provide the extra storage space that customers require over and above the storage capacity of their primary living facility.

Other proposals have involved systems for storing items. The problem with these storage systems is that they do not allow the storage space owner access to a network of potential renters. Also, the parameters and conditions for the renter and the storage space owner are not considered when matching the parties. Even though the above cited systems for storing items meet some of the needs of the market, a system that allows a storage space owner to rent out extra storage space to a renter based on inputted parameters from both parties; whereby the storage space renter inputs storage space parameters, including: location of the available storage space, dimensions of the available storage space, and time availability of the storage space; whereby the renter inputs storage item parameters, including: a desired location, a budget limit, a desired length of storage time, approximate quantity and dimensions of items, and dangerous effect of the item, if any; whereby an algorithm calculates the parameters from both parties to determine the appropriate location, storage space dimensions, quantity and size of cardboard boxes for storing the items, and final storage fee, deposits, and hazard fees, is still desired.

### SUMMARY

Illustrative embodiments of the disclosure are generally directed to a computer-implemented system and method for renting excess storage space. The system and method provide an online platform for a storage space owner to rent out extra storage space to a renter, with the conditions of the rental being based on inputted parameters from both parties. The system and method are operative to establish interactive communication between the storage space owner and the renter, and allow each party to input parameters so that an algorithm can compute and recommend a storage space that meets the renter's location requirements, required storage space size, budget, and time availability.

In some embodiments, the storage space renter inputs one or more storage space parameters, including: location of the offered storage space, dimensions of the offered storage space, time availability of the offered storage space, a video walkthrough of the available storage space, and proof of ownership for the storage space. Similarly, the renter inputs one or more storage item parameters, including: a desired location, a budget limit, a desired length of storage time, approximate quantity and dimensions of the items that require storage, and dangerous effect of the items, if any. An algorithm calculates the parameters from both parties to determine the appropriate location, storage space dimensions, quantity and size of cardboard boxes for storing the items, and final price for the storage space. Based on the calculation, the storage space owner and the renter are matched, and allowed to communicate for transacting the rental agreement.

In one aspect, a computer-implemented method for renting excess storage space, comprises:

identifying, by a storage space owner; an excess storage space;

offering, on an online platform, the excess storage space for rental;

inputting, by the storage space owner into a central processor, one or more storage space parameters, whereby the central processor comprises an algorithm operable to calculate storage space-related parameters;

searching the online platform, by a renter, for storage space for one or more items;

inputting, by the renter into the central processor, one or more storage item parameters;

calculating, with the algorithm, at least one optimal storage space for the one or more items;

displaying on the online platform, to the renter, the at least one optimal storage space for the one or more items; and

upon acceptance of the at least one optimal storage space, connecting the storage space owner to the renter on the online platform.

In another aspect, the method further comprises, paying, by the renter, a fee to the storage space owner for use of the selected optimal storage space.

In another aspect, the method further comprises, offering, by a moving company, to move the items to the selected optimal storage space for a moving fee.

In another aspect, the method further comprises, uploading to the online platform, by the storage space owner, a video of the offered storage space.

In another aspect, the method further comprises, uploading to the online platform, by the storage space owner, proof of ownership or stewardship of the offered storage space.

In another aspect, the method further comprises, purchasing insurance, by the renter, for the items in the selected optimal storage space.

In another aspect, the method further comprises, paying a deposit, by the renter, for the selected optimal storage space.

In another aspect, the method further comprises, calculating, with the algorithm, a storage fee for renting the at least one optimal storage space.

In another aspect, the method further comprises, calculating, with the algorithm, the quantity of cardboard boxes required to package the one or more items for storage.

In another aspect, the method further comprises, displaying on the online platform, to the renter, the storage fee, the location, the dimensions, and at least one rental condition for the at least one optimal storage space.

In another aspect, the method further comprises, providing a rate card to help determine the storage fee.

In another aspect, the rate card comprises a market value for storage space, based on the location and the dimensions of rented storage space in the market.

In another aspect, the method further comprises, advertising the offered excess storage space on the online platform.

In another aspect, the method further comprises, paying, by the renter, a storage fee to the storage space owner through the online platform.

In another aspect, the storage space includes at least one of the following: a room in a house, a room in an office, a garage, a warehouse space, a backyard, a shed, and a van.

In another aspect, the online platform comprises an internet marketplace that is downloadable through a software application.

In another aspect, the algorithm calculates the dimensions of the offered storage space, and the location of the offered storage space.

In another aspect, the one or more storage space parameters include at least one of the following: the location of the offered storage space, the dimensions of the offered storage space, time availability of the offered storage space.

In another aspect, the one or more storage item parameters include at least one of the following: a desired location, a budget limit, a desired length of storage time, approximate quantity and dimensions of the items that require storage, and dangerous effect of the items.

In another aspect, the step of calculating, with the algorithm, at least one optimal storage space for the one or more items, further comprises calculating a square foot of the offered storage space, a location of the storage space, a quantity and dimension of the item, and the storage time.

One objective of the present invention is to facilitate rental of excess storage space in a home or office.

Another objective is to enable anyone who has extra storage space that is not used in their home or office to rent the storage space one an easy to use, online platform.

Yet another objective is to provide an algorithm that calculates parameters form the storage space owner and the renter to calculate the optimal storage space for the renter's items.

An exemplary objective is to provide cost effective rental space for a renter.

Additional objectives are to provide an easy to navigate online platform where a storage space owner and a renter can communicate for transacting a rental for a space in a property.

An exemplary objective is to an inexpensive to produce system and method for renting excess storage space.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a block diagram of an exemplary system for renting excess storage space, in accordance with an embodiment of the present invention;

FIG. 2 illustrates a block diagram of an exemplary computer-implemented method for renting excess storage space, in accordance with an embodiment of the present invention;

FIG. 3 illustrates a computer system block diagram for an exemplary computer-implemented system for renting storage space, in accordance with an embodiment of the present invention; and

FIG. 4 illustrates a block diagram depicting an exemplary client/server system used by an exemplary web-enabled/networked embodiment, in accordance with an embodiment of the present invention.

Like reference numerals refer to like parts throughout the various views of the drawings.

### DETAILED DESCRIPTION OF THE INVENTION

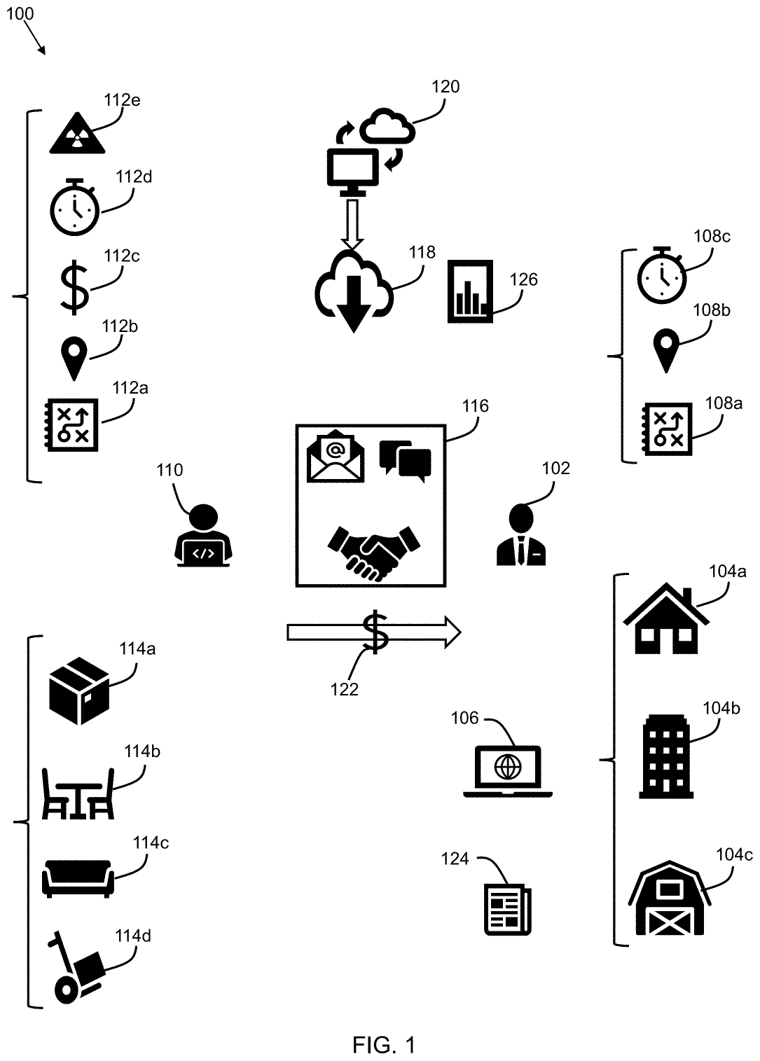

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A computer-implemented system 100 and method 200 for renting excess storage space is referenced in FIGS. 1-4. The system 100 and method 200 for renting excess storage space provide an online platform 116 for a storage space owner 102 to rent out extra storage space 104a-c to a renter 110, with the conditions of the rental being based on inputted parameters 104a-c, 114a-d from both parties. The system 100 is configured to establish interactive communication between the storage space owner 102 and the renter 110, and allow each party to input parameters 104a-c, 114a-d so that an algorithm 118 can compute and recommend an optimal storage space 104a that meets the renter's required storage space dimensions for items 112a, location requirements 112b, budget 112c, time availability 112d.

In operation of the system 100 and method 200 for renting excess storage space 104a-c, the storage space owner 102 inputs one or more storage space parameters 108a-c, including: dimensions of the offered storage space 104a, location of the offered storage space 104b, and time availability of the offered storage space 104c. Other pertinent parameters may also be used to help describe the offered storage space 104a-c. Storage space owner 102 may also upload, or input, a video 106 showing a walkthrough of the available storage space 104a-c, and proof of ownership 124 for the storage space 104a-c.

Similarly, the renter 110 inputs one or more storage item parameters 112a-e, including: approximate quantity and dimensions of the items 112a, a desired location 112b, a budget limit 112c, a desired length of storage time 112d, and dangerous effect 112e of the items 114a-d, if any. An algorithm 118 calculates the parameters from both parties 102, 110 to determine the appropriate location, storage space dimensions, quantity and size of cardboard boxes for storing the items, and final price for the storage space 104a-c. Based on the calculation, the storage space owner 102 and the renter 110 are matched, and allowed to communicate through the online platform 116 for transacting a rental agreement.

Looking now at block diagram in FIG. 1, the system 100 for renting excess storage space, hereafter “system 100” initially provides at least one excess storage space 104a-c, which is under ownership, or stewardship, of a storage space owner 102. In some embodiments, the storage space 104a-c may include, without limitation, a room in a house 104a, a room in an office 104b, a garage 104c, a warehouse space, a backyard, a shed, a parking lot, and a van or truck. The storage space 104a-c is defined as an enclosure or space that the storage space owner 102 has no use for, and is looking to monetize. For example, an extra bedroom in the house, or a shed in the backyard. However, in other embodiments, any type of enclosure or space that can store items 114a-d encompasses the present invention.

The system 100 is operable through an online platform 116 that is configured to display, advertise, and transact a rental agreement for the excess storage space 104a-c. In one embodiment, the online platform 116 is a marketplace that is accessible through the Internet. A network of storage space owners and renters can register and access the online platform. In some embodiments, access to the online platform 116 is free. In other embodiments, access is available after paying a fee. The online platform 116 may be downloadable on a mobile communication device, a laptop, a tablet, and a computer.

In some embodiments, a central processor 120 is operably connected to the online platform 116 to store, process, and display information provided by the storage space owner 102 and renter 110 in regards to the excess storage space 104a-c. The online platform 116 may be operable with an open-source software, and stores information on a social server, or other cloud database service known in the art. In other embodiments, a server, cloud, and database may also be used for processing such information, as is known in the art. The online platform 116 is akin to a network of potential storage space owners and renters create a profile, and then have access to other network members needing the service of a storage space 104a-c and/or a renter 110 to rent the storage space 104a-c.

In attempting to rent the excess storage space 104a-c, the storage space owner 102 accesses the online platform 116. The storage space owner 102 has access to the online platform 116, through a registration, login, and network joining process, as is known in the art. For example, the storage space owner 102 can register personal information, advertise the storage space 104a-c, and upload a video walkthrough of the storage space 104a-c. This allows perspective renters to see the storage space 104a-c to make a more informed decision. And as required by the system 100, the storage space owner 102—through the online platform 116—also inputs one or more storage space parameters 108a-c into the central processor 120. It is significant to note that information/data inputted through the online platform 116 in a standard log in process is transmitted to the central processor 120, servers, clouds, and other processing components known in the art of online transactions and networked communications.

The one or more storage space parameters 108a-c are parameters that help define the storage space 104a-c being offered by the storage space owner 102. These allow the central processor 120 to compute the information, and help the renter 110 better understand the storage space 104a-c being offered for rent. For example, exemplary storage space parameters 108a-c may include, without limitation, the location of the offered storage space 104a-c, the dimensions of the offered storage space 104a-c, time availability of the offered storage space 104a-c.

The system 100 provides a central processor 120, or business processing engine for computing the optimal storage space 104a-c for the items 114a-d needing storage, and other parameters requested by the renter 110. The central processor 120 comprises an algorithm 118 operable to calculate storage space 104a-c-related parameters. The location is important, since the renter 110 may not want to travel to far with the items 114a-d to put them in storage. The dimensions of the storage space 104a-c are also important, in order to calculate if it is enough, or too much space for the items 114a-d requiring storage. The time availability indicates how long the storage space 104a-c will be available, which must correlate to the renter's required length of storing the item. In one example, an “Open” term may be used to indicate that the time of availability is infinite.

The renter 110 is the party who has one or more items 114a-d that require storage. The items 114a-d may include, without limitation, boxed items 114a, furniture 114b-114c, boxed clothes 114d, toys, precious metals, vehicles, and any item known in the art to require storage. The renter 110 also has access to the online platform 116, through a registration, login, and network joining process, as is known in the art. For example, the renter 110 can register personal information and financial information, i.e., credit card, and then join the online platform 116 with other network members, i.e., storage space owners and renters. The storage space owners may be in communication before a rental transaction occurs, or may not be allowed to communicate until a match for an appropriate rental space is found.

The renter 110 inputs one or more storage item parameters 112a-e into the central processor 120, through the online platform 116. The one or more storage item parameters 112a-e are the defining characteristics of the items 114a-d that are necessary to calculate an appropriate storage space 104a-c therefor. Exemplary storage item parameters 112a-e may include, without limitation, approximate quantity and dimensions of the items 112a, a desired location for storing the items 112b, a budget limit 112c, a desired length of storage time for storing the items 112d, and dangerous effect 112e of the items, if any. The dangerous effect can include items that are hazmat, flammable, radioactive, and biological hazards. However, additional storage item parameters 112a-e may also be used to match an appropriate storage space 104a-c thereto. For example, if the renter 110 has a vehicle with a length of 182″ and a width of 70″, the storage space 104a-c must have these minimum dimensions, along with an access driveway for the Toyota. Similarly, five cardboard boxes filled with used baby clothes would not require a large garage, but more appropriately, a small room in a house or office would be a better storage space 104a-c match.

The system 100 is unique in that an algorithm 118 that receives the parameters uses a formula or processing method, or artificial intelligence to match the items 114a-d with an optimal storage space 104a. The calculation is a preprogrammed array of parameters, such as: the dimensions of the offered storage space, the location of the offered storage space, the quantity and the dimension of the item, and the required storage time. Additional preprogrammed parameters may include: a square foot of the offered storage space, a location of the offered storage space, a quantity and dimension of the item, and the required storage time. Yet more parameters may be used, which are pertinent to the storage space 104a-c and/or the items 114a-d.

In one example, the algorithm 118 determines that the cost of renting a storage space 104a-c is based on the formula: square feet+type of space=Rental Cost. The square feet are a standard fee with tiers of prices. For example, less than 200 square feet is $20/day. Between 200-400 square feet is $40/day. Over 400 square feet is $50/day. The type of dimensions and storage space 104a-c is based on a chart. The algorithm 118 is also programmed to calculate that a room inside a home is $50/day. A garage is $30/day. An outdoor space is $20/day. The algorithm 118 is also programmed to eliminate storage spaces that are located more than 50 miles from the renter's location or the items 114a-d. The algorithm 118 is unique in that any permutation of parameters may be used to determine the appropriate storage space 104a-c for the items 114a-d.

In another example of calculations, the algorithm 118 searches correlating storage spaces in the region of the offered storage space 104a-c. The dimensions of the storage spaces are also tabulated. These are matched with the renter's items 114a-d, and desired budget, storage time requirements, and other parameters to achieve the optimal match, based partly on the market price in the region. Those skilled in the art will recognize that the algorithm 118 may also utilize artificial intelligence programming (AI) to match the optimal storage space 104a-c with the renter's storage needs. This may involve artificial intelligence programs, including the following fields: cybernetics and brain simulation, cognitive simulation, computational intelligence and soft computing, probabilities, and statistics. In this AI embodiment, the parameters are fed into the algorithm 118, and using statistical techniques, the algorithm 118 progressively gets better at determining the optimal storage space 104a, based on historical matches, without having been specifically programmed for a specific storage space.

In alternative embodiments of the system 100, the algorithm 118 may even utilize deep learning, in which the parameters are inputted through a biologically-inspired neural network architecture. The neural networks contain a number of hidden layers through which the parameters are processed, allowing the central processor 120 to go deep in its learning, making connections and weighting input for the best storage space 104a-c options. In yet other embodiments, a rate card 126 can be used with, or in place of the algorithm 118. The rate card 126 is configured to help determine the storage fee 122 for the offered storage space 104a-c. The rate card 126 comprises a market value for storage space 104a-c, with the market value being based on the location and the dimensions of rented storage space 104a-c in the market. In essence, a market value search for the renter's desired region.

In yet another example of the algorithm 118 calculating formula involves a table that has predetermined parameters and correlating points. As a parameter is determined, points are assigned. For example, having a storage space 104a-c within ten miles of the renter 110 scores 10-points, but having a storage space 104a-c within 2-miles of the renter 110 scores 20-points. A similar point structure can be applied for dimensions of the storage space 104a-c, time availability, and capacity to contain hazardous materials. At the end of the tabulations, the highest point totals are deemed the optimal storage space 104a-cs for the items 114a-d in question.

After the optimal storage space 104a, or multiple optimal storage spaces 104a-c are determined, they are displayed on the online platform 116 to the renter 110. However, in other embodiments, the renter 110 can receive a text, an email, or other message to indicate that the optimal storage space 104a-c is now available for viewing. The renter will then have time to determine if the storage space is appropriate, ask questions, or refuse the storage space. Finally, upon acceptance of the at least one optimal storage space 104a-c, the storage space owner 102 may be connected to the renter 110 through the online platform 116. However, in other embodiments, the system 100 maintains separation between the parties, collecting fees, providing directions, and other functions, without requiring the storage space owner 102 and renter 110 to meet or communicate with each other.

As FIG. 1 references, the system 100 enables the storage space owner 102 to be compensated for the optimal storage space 104a-c selected by the renter 110. This is in the form of a storage fee paid to the storage space owner 102 through the online platform 116, or directly from the renter 100, without help of the online platform 116. In alternative embodiments, the renter 110 may also be required to pay a deposit, insurance, and other fees known in the art of rental. The renter 110 may also be connected to a moving company (not shown) to help transfer the items 114a-d to the storage space 104a-c. In the case of storing hazardous materials, the renter 110 must give a reason for using the storage space 104a-c, and if dangerous, pay an additional hazmat fee.

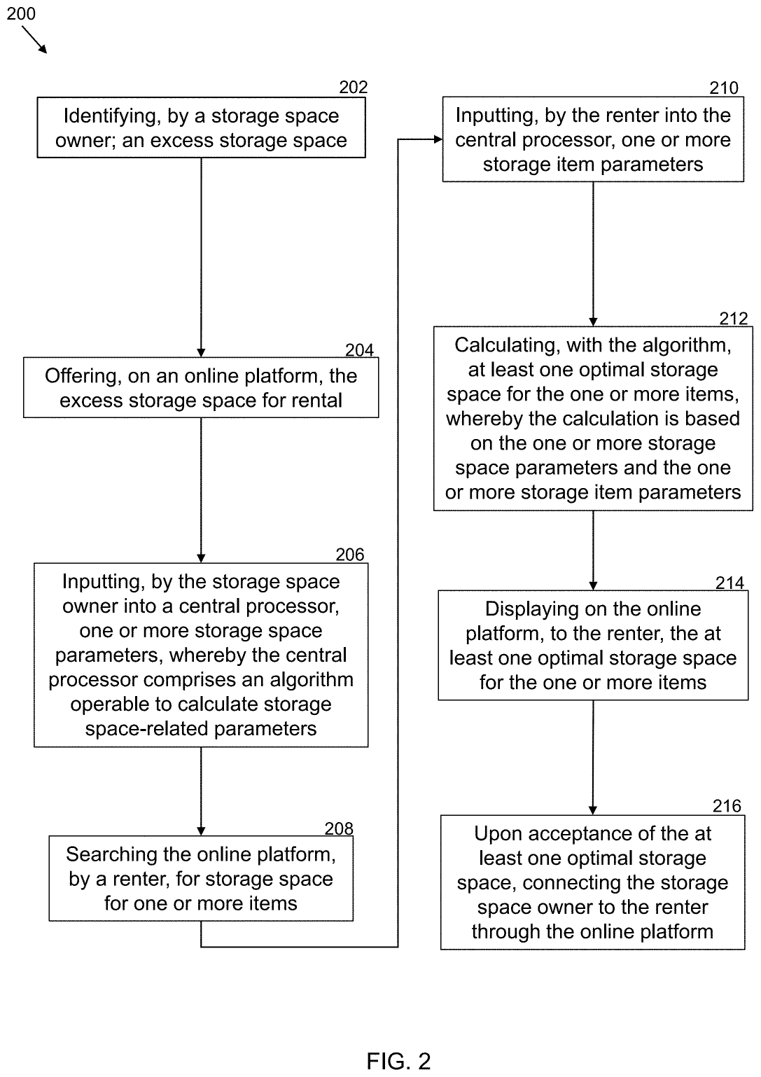

FIG. 2 illustrates a flowchart diagram of an exemplary method 200 for renting excess storage space. The method 200 may include an initial Step 202 of identifying, by a storage space owner; an excess storage space. In some embodiments, the storage space may include, without limitation, a room in a house, a room in an office, a garage, a warehouse space, a backyard, a shed, and a van. The storage space 104a-c is defined as an enclosure or space that the storage space owner 102 has no use for, and is looking to monetize. For example, an extra bedroom in the house, or a shed in the backyard.

The method 200 may further comprise a Step 204 of offering, on an online platform, the excess storage space for rental. In attempting to rent the excess storage space 104a-c, the storage space owner 102 accesses the online platform 116. The storage space owner 102 has access to the online platform 116, through a registration, login, and network joining process, as is known in the art. For example, the storage space owner 102 can register personal information, advertise the storage space 104a-c, and upload a video walkthrough of the storage space 104a-c. This allows perspective renters to see the storage space 104a-c to make a more informed decision. In another novel Step, the method 200 comprises advertising the offered excess storage space on the online platform. Another Step provided by the method 200 may include, uploading to the online platform, by the storage space owner, a video of the offered storage space. This helps create a visual for the renter. Another Step provided by the method 200 may include, uploading to the online platform, by the storage space owner, proof of ownership or stewardship of the offered storage space. This builds confidence in the renter that the storage space is legitimate and safe to store the items.

A Step 206 includes inputting, by the storage space owner into a central processor, one or more storage space parameters, whereby the central processor comprises an algorithm operable to calculate storage space-related parameters. In some embodiments, the one or more storage space parameters include at least one of the following: the location of the offered storage space, the dimensions of the offered storage space, time availability of the offered storage space. In some embodiments, a Step 208 comprises searching the online platform, by a renter, for storage space for one or more items. The renter can search through region/location, size, and time availability of storage spaces.

A Step 210 includes inputting, by the renter into the central processor, one or more storage item parameters. In one possible embodiment, the one or more storage item parameters include at least one of the following: a desired location, a budget limit, a desired length of storage time, approximate quantity and dimensions of the items that require storage, and dangerous effect of the items. In some embodiments, a Step 212 may include calculating, with the algorithm, at least one optimal storage space for the one or more items, whereby the calculation is based on the one or more storage space parameters and the one or more storage item parameters. In some embodiments, the calculation by the algorithm may include variables and parameters, such as: the dimensions of the offered storage space, the location of the offered storage space, the quantity and the dimension of the item, and the required storage time.

Another Step provided by the method 200 may include, calculating, with the algorithm, a storage fee for renting the at least one optimal storage space. The storage fee 122 is one that fits the renter's budget parameter. In another novel Step, the method 200 comprises calculating, with the algorithm, the quantity of cardboard boxes required to package the one or more items for storage. This can also include types of boxes, and other moving accessories. Another Step provided by the method 200 may include, providing a rate card to help determine the storage fee, the rate card comprising a market value for storage space, the market value being based on the location and the dimensions of rented storage space in the market.

Continuing with FIG. 2, the method 200 further includes a Step 214 of displaying on the online platform, to the renter, the at least one optimal storage space for the one or more items. The renter will then have time to determine if the storage space is appropriate, ask questions, or refuse the storage space. Yet another Step may include displaying on the online platform, to the renter, the storage fee, the location, the dimensions, and at least one rental condition for the at least one optimal storage space. A final Step 216 includes upon acceptance of the at least one optimal storage space, connecting the storage space owner to the renter through the online platform.

However, in alternative embodiments, yet another Step may include purchasing insurance, by the renter, for the one or more items in the selected optimal storage space. Another Step provided by the method 200 may include, paying through the online platform, by the renter, a storage fee to the storage space owner for renting the at least one optimal storage space. Yet another Step may include paying through the online platform, by the renter, a deposit for the selected optimal storage space. In another novel Step, the method 200 comprises offering, by a moving company, to move the items to the selected optimal storage space for a moving fee. The moving company can be employed by the online platform, the storage space owner; or may be an independent company.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

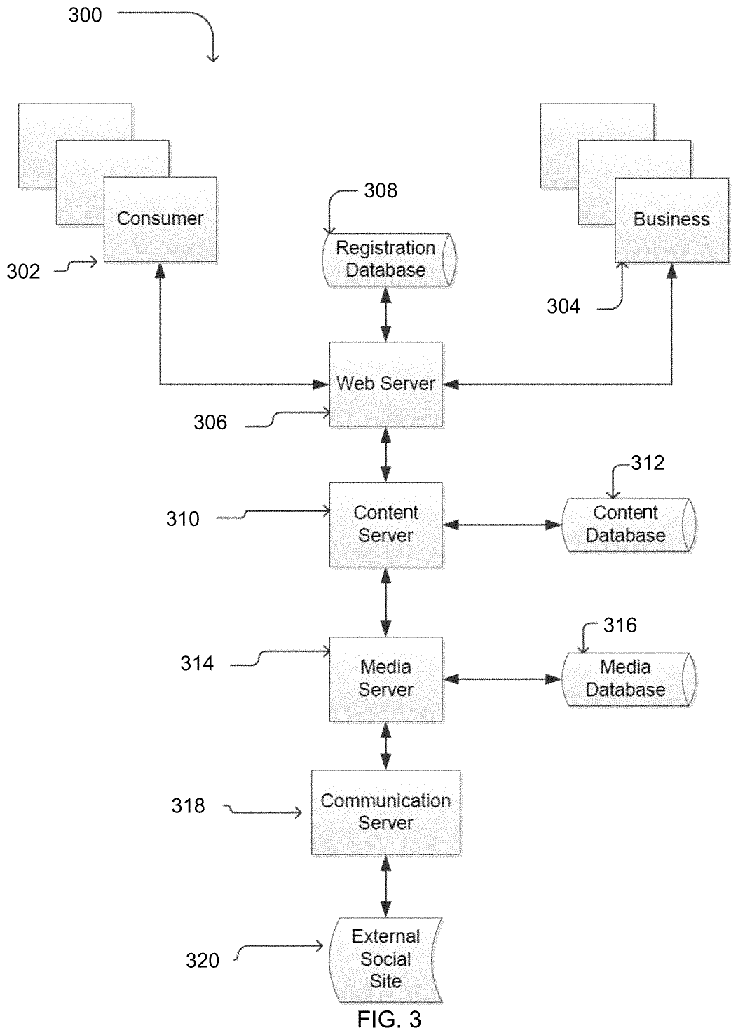

FIG. 3 illustrates a computer system block diagram for an exemplary computer-implemented system 300 for renting storage space, in accordance with an embodiment of the present invention. In system 300, object sender 302 and object recipient 404 communicate with web server 306. Object sender 302 and object recipient 304 may register with system 300. Web server 306 may store object sender and object recipient information in registration database 308. Object sender 302 and object recipient 304 may transfer media to web server 306. Content server 310 may format and store transferred object information in content database 312. Media server 314 may format and store transferred object information in media database 316 for system 300. Communication server 318 may administer and store object information in content database 312 and/or media database 316. Communication server 318 may also serve to transfer object files to an external social site 320.

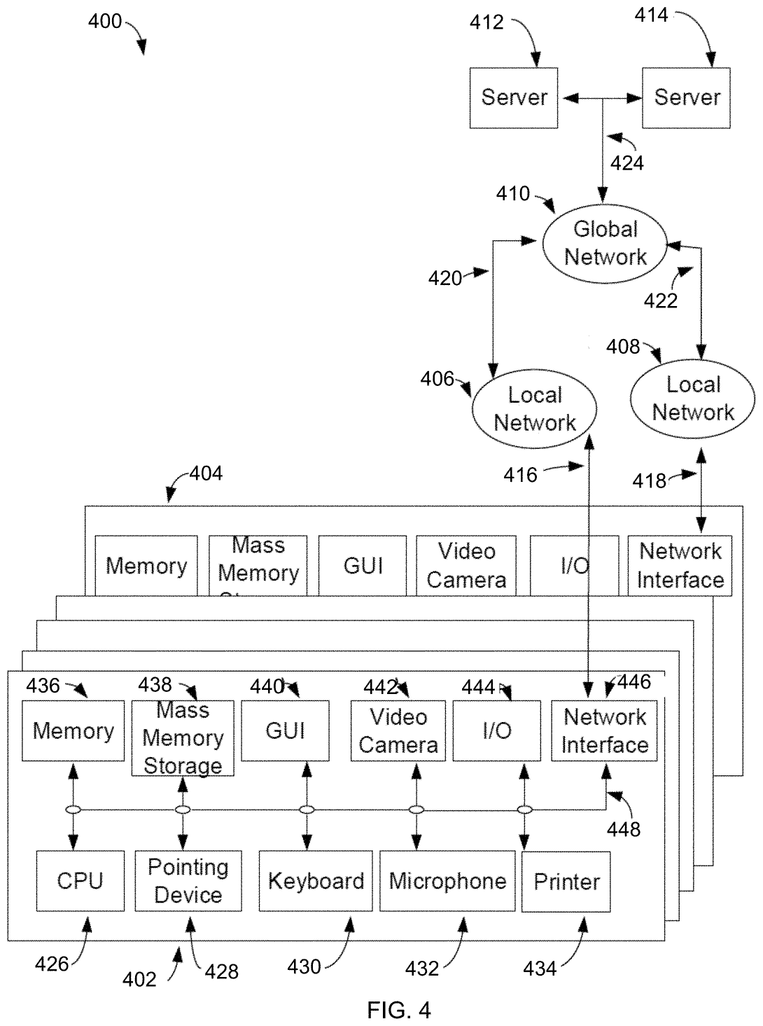

FIG. 4 is a block diagram depicting an exemplary client/server system which may be used by an exemplary web-enabled/networked embodiment of the present invention. A communication system 400 includes a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate bi-directionally with local network 406 via a communication channel 416. Client 404 may communicate bi-directionally with local network 408 via a communication channel 418. Local network 406 may communicate bi-directionally with global network 410 via a communication channel 420. Local network 408 may communicate bi-directionally with global network 410 via a communication channel 422. Global network 410 may communicate bi-directionally with server 412 and server 414 via a communication channel 424. Server 412 and server 414 may communicate bi-directionally with each other via communication channel 424. Furthermore, clients 402, 404, local networks 406, 408, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WANs), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 436, mass memory storage 438, GUI 440, video camera 442, input/output interface 444 and network interface 446 may communicate in a unidirectional manner or a bi-directional manner with each other via a communication channel 448. Communication channel 448 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 426 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

In conclusion, a system 100 and method 200 for renting excess storage space provides an online platform for a storage space owner to rent out extra storage space to a renter. The method is operative to establish interactive communication between the storage space owner and the renter, allowing each party to input parameters so that an algorithm can compute and recommend a storage space that meets the renter's location requirements, required storage space size, budget, and time availability. The storage space renter inputs one or more storage space parameters. Similarly, the renter inputs one or more storage item parameters. An algorithm calculates the parameters from both parties to determine the appropriate location, storage space dimensions, quantity and size of cardboard boxes for storing the items, and final price for the storage space. Based on the calculation, the storage space owner and the renter are matched, and allowed to communicate for transacting the rental agreement.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

1. One or more computer storage media storing computer-usable instructions, that when used by one or more computing devices, cause the one or more computing devices to perform a computer-implemented method for renting excess storage space, the method comprising:
identifying, by a storage space owner; an excess storage space;
offering, on an online platform, the excess storage space for rental;
inputting, by the storage space owner into a central processor, one or more storage space parameters, whereby the central processor comprises an algorithm operable to calculate storage space-related parameters;
searching the online platform, by a renter, for storage space for one or more items;
inputting, by the renter into the central processor, one or more storage item parameters;
calculating, with the algorithm, at least one optimal storage space for the one or more items, whereby the calculation is based on the one or more storage space parameters and the one or more storage item parameters;
displaying on the online platform, to the renter, the at least one optimal storage space for the one or more items; and
upon acceptance of the at least one optimal storage space, connecting the storage space owner to the renter through the online platform.

2. The method of claim 1, further comprising, uploading to the online platform, by the storage space owner, proof of ownership or stewardship of the offered storage space.

3. The method of claim 1, further comprising, advertising the offered excess storage space on the online platform.

4. The method of claim 1, further comprising, uploading to the online platform, by the storage space owner, a video of the offered storage space.

5. The method of claim 1, further comprising, purchasing insurance, by the renter, for the one or more items in the selected optimal storage space.

6. The method of claim 1, whereby the calculation by the algorithm includes at least one of the following: the dimensions of the offered storage space, the location of the offered storage space, the quantity and the dimension of the item, and the required storage time.

7. The method of claim 1, further comprising, calculating, with the algorithm, a storage fee for renting the at least one optimal storage space.

8. The method of claim 7, further comprising, displaying on the online platform, to the renter, the storage fee, the location, the dimensions, and at least one rental condition for the at least one optimal storage space.

9. The method of claim 8, further comprising, paying through the online platform, by the renter, the storage fee to rent the at least one optimal storage space.

10. The method of claim 9, further comprising, paying through the online platform, by the renter, a deposit for the selected optimal storage space.

11. The method of claim 7, further comprising, providing a rate card to help determine the storage fee, the rate card comprising a market value for storage space, the market value being based on the location and the dimensions of rented storage space in the market.

12. The method of claim 1, further comprising, calculating, with the algorithm, the quantity of cardboard boxes required to package the one or more items for storage.

13. The method of claim 1, further comprising, offering, by a moving company, to move the items to the selected optimal storage space for a moving fee.

14. The method of claim 1, wherein the storage space includes at least one of the following: a room in a house, a room in an office, a garage, a warehouse space, a backyard, a shed, and a van.

15. The method of claim 1, wherein the one or more storage space parameters include at least one of the following: the location of the offered storage space, the dimensions of the offered storage space, time availability of the offered storage space.

16. The method of claim 1, wherein the one or more storage item parameters include at least one of the following: a desired location, a budget limit, a desired length of storage time, approximate quantity and dimensions of the items, and dangerous effect of the items.

17. One or more computer storage media storing computer-usable instructions, that when used by one or more computing devices, cause the one or more computing devices to perform a computer-implemented method for renting excess storage space, the method consisting of:
identifying, by a storage space owner; an excess storage space;
offering, on an online platform, the excess storage space for rental, the online platform comprising an internet marketplace that is downloadable through a software application;
inputting, by the storage space owner into a central processor, one or more storage space parameters, the one or more storage space parameters including at least one of the following: the location of the offered storage space, the dimensions of the offered storage space, time availability of the offered storage space, whereby the central processor comprises an algorithm operable to calculate storage space-related parameters;
uploading to the online platform, by the storage space owner, proof of ownership or stewardship of the offered storage space;
searching the online platform, by a renter, for storage space for one or more items;
inputting, by the renter into the central processor, one or more storage item parameters, the one or more storage item parameters including at least one of the following: a desired location, a budget limit, a desired length of storage time, approximate quantity and dimensions of the items, and dangerous effect of the items;
calculating, with the algorithm, at least one optimal storage space for the one or more items, the calculation by the algorithm including at least one of the following: the dimensions of the offered storage space, the location of the offered storage space, the quantity and the dimension of the item, and the required storage time, the calculation by the algorithm including at least one of the following: a square foot of the offered storage space, a location of the offered storage space, a quantity and dimension of the item, and the required storage time;
displaying on the online platform, to the renter, the at least one optimal storage space for the one or more items;
upon acceptance of the at least one optimal storage space, connecting the storage space owner to the renter through the online platform; and
paying, by the renter, a storage fee to the storage space owner through the online platform.

18. A system for renting excess storage space, the system comprising:
an excess storage space under stewardship of a storage space owner;
an online platform displaying the excess storage space for rental;
one or more storage space parameters inputted into a central processor by the storage space owner, whereby the central processor comprises an algorithm operable to calculate storage space-related parameters;
one or more storage item parameters inputted by the renter into the central processor;
at least one optimal storage space calculated by the algorithm for the one or more items, the calculation by the algorithm including at least one of the following: the dimensions of the offered storage space, the location of the offered storage space, the quantity and the dimension of the item, and the required storage time, the calculation by the algorithm including at least one of the following: a square foot of the offered storage space, a location of the offered storage space, a quantity and dimension of the item, and the required storage time;
whereby the at least one optimal storage space for the one or more items displays on the online platform to the renter;
whereby, upon acceptance of the at least one optimal storage space, connecting the storage space owner to the renter through the online platform; and
a storage fee paid by the renter to the storage space owner through the online platform.

19. The system of claim 18, wherein the one or more storage space parameters include at least one of the following: the location of the offered storage space, the dimensions of the offered storage space, time availability of the offered storage space.

20. The system of claim 18, wherein the one or more storage item parameters include at least one of the following: a desired location, a budget limit, a desired length of storage time, approximate quantity and dimensions of the items, and dangerous effect of the items.
